(19) United States
(12) Patent Application Publication
(10) Pub. No.: US 2022/0322870 A1
(43) Pub. Date: Oct. 13, 2022

(54) FOOD HEATING SYSTEM AND METHOD FOR PICK-UP OR DELIVERY

(71) Applicant: Inductive Intelligence, LLC, Fennville, MI (US)

(72) Inventors: David W Baarman, Fennville, MI (US); Gregory L. Clark, Ada, MI (US); Benjamin C. Moes, Wyoming, MI (US)

(21) Appl. No.: 17/621,032

(22) PCT Filed: Jun. 18, 2020
(86) PCT No.: PCT/US2020/038416

§ 371 Date: Dec. 20, 2021

Related U.S. Application Data
(60) Provisional application No. 62/864,603, filed on Jun. 21, 2019.

(51) Int. Cl. A47J 36/32; G06Q 10/08; A47J 36/26; A47J 36/24; H05B 6/06

(52) U.S. Cl. CPC A47J 36/32; G06Q 10/0832; G06Q 10/08355; A47J 36/26; A47J 36/2483; H05B 6/06

(57) ABSTRACT

An intelligent heating system and method for providing varied heating experiences to food product packages and their contents in connection with pick-up food service, delivery food service, or both. The intelligent heating system dynamically controls energy provided to food packages and their contents in order to provide different heating experiences. The system can use location information to heat the food just before pick-up or delivery to enhance the consumption experience. The system can also control temperature to reduce the amount of condensation that forms within the package.

### BACKGROUND OF THE INVENTION

The disclosure relates to smart or intelligent appliances and systems and methods for transferring energy, such as by induction, to objects, including packages and packaged contents. The disclosure also relates to devices, systems, and methods for monitoring and controlling the heating experience of a package and/or its contents.

Energy transfer appliances for cooking, such as induction cooking appliances, are generally well known in the prior art. Such systems involve a heating element that transfers energy, for example by induction, to a receptor or cooking vessel which ultimately results in heating. Moreover, automated cooking systems and packaging systems that utilize energy transfer components, such as microwave popcorn packaging with an internal heating element, are generally known. Many of these cooking and packaging systems have problems such as a rigid application of the same process for energy transfer to heat any object, regardless of the specific heating requirements for the package contents or contents within a cooking vessel. Further, the processes associated with these packages are often not automated and controlled based on specific contents. In addition, some of the existing systems lack adequate package/product validation.

Some mobile heating systems have to include large gas systems for cooking or include a massive power system to account for the required parallel energy for these systems.

Some heating appliances and smart packaging systems address some of these issues. For example, WO2018/183574 entitled “Smart Appliances, Systems and Methods” to Clark et al., filed Mar. 28, 2018, which is herein incorporated by reference in its entirety, discusses a number of different embodiments of smart package and smart package heating/charging appliances.

Many food items have optimal flavor and freshness when served hot. However, maintaining food temperature after cooking is complete can be a challenge, especially in the food pick-up and delivery situations. One issue with delivery or pick-up food services is that the temperature of the food can decline before the food is delivered to the customer or before the customer is able to pick-up and return home to consume the food. In order to address these issues, food pick-up and delivery services employ a variety of different systems to attempt to keep the food warm or reduce the speed at which the temperature decays. For example, heat lamps, heated plates, thermally insulated bags, thermally controlled delivery vehicles, and heating racks have been used to varying degrees of success. These solutions can cause other issues — for example, heating systems can dry out or overcook the food if utilized for extended periods while packaging the food can lead to condensation forming and negatively impacting the customer's food experience. Additionally, these systems tend to be designed to provide food at one temperature, where oftentimes the different food in an order is meant to be experienced at a variety of different temperatures for the best experience. Further, as the complexity of pick-up and delivery has increased, the power used for these systems can be an issue. Energy needed for warming systems in vehicles can be a burden for food delivery services like Uber Eats, Grubhub, and Doordash.

The demand for delivery of hot foods to consumers has grown in recent years due, at least in part, to an increasing number of third party food delivery services and additionally more and more restaurants and other merchants offering delivery food services themselves. The rise in pizza deliveries is a prime example, however, many other foods are now commonly available for delivery to customers' doors, including hot sandwiches, Chinese and Mexican food, as well as complete meals. In these cases where food is prepared and cooked at one location and then delivered to remotely located customers, there is a delay between the time that the food is prepared and the time that the food is consumed. Accordingly, by the time the customer is ready to eat, the freshness, flavor, temperature, or other characteristics of the food may be unsatisfactory. For example, one common problem with delivery of hot, packaged food, is that condensation can form on the internal surfaces of the packaging, which tends to turn crispy food soggy. Another issue is that delivery drivers often deliver multiple food orders to different households sequentially. While early deliveries in the driver's route may reach the customer at a satisfactory temperature, later deliveries may not.

Many restaurants and merchants offer order-ahead or pick-up services, which some customers prefer. However, many aspects of the order-ahead process are imprecise. When an order is placed, if the order is for immediate consumption the restaurant typically begins preparing the order and provides the customer with an estimated time the order will be ready for pick-up. Alternatively, the customer may request a specific pick-up date and/or time. Often the amount of time to prepare the food is less than the time it takes the customer to arrive, so the food may sit on a warming rack until the customer arrives. The time on the warming rack will be exacerbated if a customer is late or misjudged an arrival time.

Smartphones and other mobile devices, with specialized applications for placing and monitoring food pick-up and delivery orders are being used to streamline interactions between consumers and merchants. Some of these applications assist in efficiently routing food orders to the food pick-up or delivery source, but they do not address the food experience issues created by the food pick-up and delivery processes.

### SUMMARY OF THE INVENTION

The present invention provides an intelligent heating system for use in connection with pick-up food service, delivery food service, or both. The intelligent heating system includes an energy transfer system configured to transfer energy to heat one or more food products. The energy transfer system can be configured to provide different heating experiences for the food products at different points in time based on information that the system collects.

In one embodiment, the energy transfer system can be controlled to keep food warm during a storage period and then the food can be heated just before pick-up or delivery to enhance the consumption experience. For delivery service, a finishing heating system having an energy transfer system can be disposed in a delivery vehicle. The finishing heating system can receive or generate delivery route information, order information, and location information. The heating experience of each food product in a delivery food order can be controlled based on the estimated time of arrival of the delivery vehicle to each delivery destination. The system can map a route and the time between each location on the way. Route planning software can compare potential routes based on power usage associated with heating the orders for delivery across different delivery patterns. An appropriate delivery route can be selected from among potential delivery routes based on the power usage for the vehicle, which allows the system to manage for various metrics, such as the route that provides the lowest average power consumption over time of delivery. For pick-up service, a finishing heating system including an energy transfer system can be installed at the point of sale. The finishing heating system can receive or obtain customer location information and order information. The heating experience of each food product in a pick-up food order can be controlled based on the estimated time of arrival of the customer to the point of sale to provide desired pick-up food temperatures and create better food experiences.

For both the delivery and pick-up, the intelligent heating system can control the energy transfer system based on location information to ensure that the food is hot just before pick-up or delivery. Location information, such as estimated time of arrival, speed, distance, or geolocation information, can be tracked and can inform the control of the energy transfer system. The location information can be collected from a customer device having a radio location system for pick-up food service or a delivery vehicle or delivery driver device having a radio location system for delivery service.

In one embodiment, the intelligent heating system can include an initial heating system, such as a conventional oven, that can be configured to partially cook the food before being finished by the finishing heating system. The intelligent heating system can coordinate the cooking times, temperatures, and other operational parameters of the initial heating system and the finishing heating system to provide partial, warming, and finishing heating experiences tailored to provide just-in-time cooked food for pick-up or delivery. By only partially cooking the food and allowing the intelligent heating system to adjust the heating experience, food can be cooked just-in-time without overcooking the food, which can negatively impact its flavor and freshness. For delivery service, the finishing system installed in the delivery vehicle can complete the cooking process for each order just-in-time for delivery based on the delivery route, order, and location information. For pick-up service, the finishing system installed at the point of sale can complete the cooking process for each order just-in-time for the customer's arrival based on the order and customer location information.

The energy transfer system can heat food items directly or indirectly. In one embodiment, food is placed in a food package, such as a wrapper, box, pouch, bag, or other container, before being placed in the finishing heating system. The food packaging can be an inductively-heated package having a heating element configured to generate and distribute heat. The heating element can be configured to interact with the magnetic field provided by the energy transfer system to produce controlled heating. In other embodiments, the energy transfer system can utilize resistive heating. That is, the food package heating element may be a resistive heating element that generates heat in response to the energy transfer system applying energy indirectly, by inductively transferring energy to a separate coil that powers the resistive heating element, or directly to the resistive heating element. In another embodiment, the energy transfer system is a resistive heating system with a resistive heating element and the food packaging does not include a separate heating element. Instead, heat is applied to the food product by virtue of proximity to the resistive heating element of the energy transfer system.

In one embodiment, the intelligent heating system can coordinate heating experiences for multiple food orders, each having one or more food products. The finishing heating system can have multiple compartments for receiving food packages based on order information. An energy transfer element can be disposed in proximity of each of the compartments for transferring energy to the food packages in the compartments. A control system can receive the order information identifying which of the food packages are stored in which of the compartments and control the energy applied to the energy transfer elements to provide various heating experiences to the food packages stored in the compartments based on the order information.

The finishing heating system can include an identification system that assists in identifying which food products are stored in which compartment and/or indicating which food products should be stored in which compartment. In one embodiment, the finishing heating system includes an RFID coil disposed in proximity of each of the compartments for identifying the food packages by reading order information from an RFID tag associated with each food package. Preprogrammed information regarding storage times and temperatures, as well as final pick-up delivery temperature, can be associated with the package RFID tag so that it can be read by the identification system. Before, or as each food product of an order is filled and placed in a package with an RFID tag, the RFID tag can be written with the appropriate order information. Then, the packaged food product can be disposed in any compartment of the finishing system where the compartment will be automatically linked to the specific pick-up or delivery order by reading the RFID tag. Alternatively, in embodiments without RFID tags, the identification system can provide visual indications of which compartments to store each food order. As food orders are picked-up or delivered, the identification system can re-designate those compartments for other orders. In addition to organizing the heating experiences, the identification system can provide order tracking and verification by indicating what food packages are included in each specific food order.

The RFID tag can include a temperature sensor that provides temperature feedback to the controller of the finishing heating system. The temperature feedback can be utilized to better control the heating experience for the food product. In one embodiment, the finishing heating system and the food product temperature sensor cooperate to prevent or reduce the amount of condensation forming on the internal surfaces of the food packaging. The system has the ability to track package temperature, outdoor temperature, and ambient temperature. Based on this information, the controller can adjust the energy applied by the energy transfer system to balance providing the desired heating experience while reducing or preventing condensation.

Order, temperature readings, times and quality information can be pushed to the web for the customer and the restaurant. A pick-up or delivery check list can be read by RFID and reported to the cloud to enable a final check of everything expected. All orders and complaints can be tracked against what was packaged, when it was delivered, where it was delivered, and what was ordered.

Information may be applied to the package or container using an RFID tag or inlay. Alternatively, the information may be applied using a printed barcode, printed temperature sensing circuit, or other passive optical sensors that communicate information and/or the temperature of the package to the reader, and may be combined with direct package temperature measurement through a thermal probe or infra-red temperature sensor within the appliance.

### BRIEF DESCRIPTION OF THE DRAWINGS

The invention is described in detail below with reference to the accompanying figures in which:

FIG. 1 illustrates a representative block diagram of one embodiment of a point of sale food system;

FIG. 2 illustrates a representative block diagram of one embodiment of a package heating system;

FIG. 3A illustrates a perspective view of a Styrofoam inductively heatable package in an open configuration;

FIG. 3B illustrates a perspective view of the Styrofoam inductively heatable package in a closed configuration;

FIG. 4 illustrates a perspective view of a cardboard inductively heatable package;

FIG. 5 illustrates a perspective view of a foil inductively heatable package;

FIG. 6 illustrates one embodiment of an inductive heating rack of the present invention;

FIG. 7 illustrates an exemplary timing diagram showing the timing sequence for operation of the inductive rack for three deliveries;

FIG. 8 illustrates a route map and sequence of delivery;

FIG. 9 illustrates a pick-up map of consumer locations along with estimated time of arrivals; and

FIG. 10 illustrates psychometric chart representing the psychometric processes of air.

### DESCRIPTION OF THE CURRENT EMBODIMENT

The present invention relates to an intelligent heating system 100 for use in connection with pick-up food service, delivery food service, or both. The intelligent heating system 100 includes an energy transfer system 122 configured to transfer energy to heat one or more food products contained within a food package 108. The energy transfer system 122 can be configured to provide different heating experiences for the food product at different points in time based on information that the system collects.

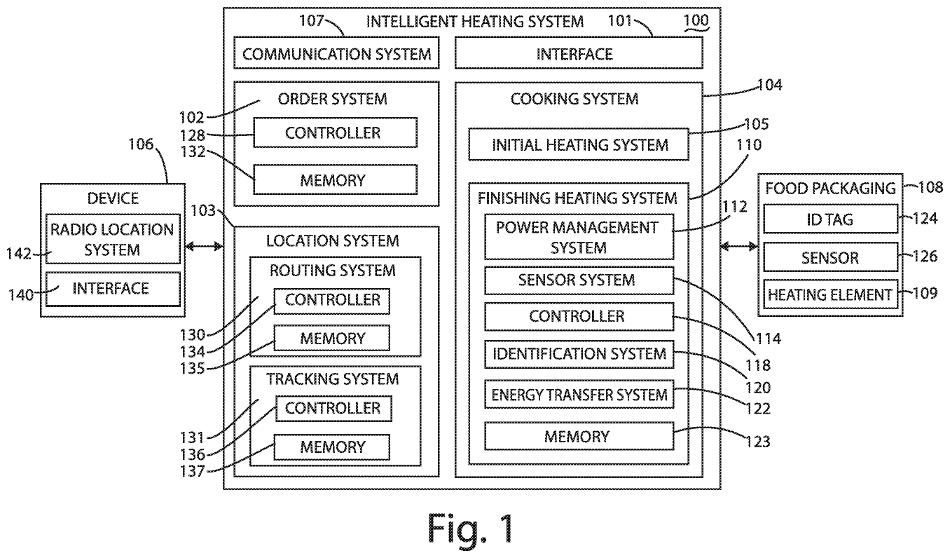

FIGS. 1-10 show various alternative embodiments of the present invention. In the various illustrated embodiments, the intelligent heating system 100 is configured to produce controlled heating experiences based on sensor 126 feedback, ID information 124, and/or communication from the food package 108 and/or third party devices 106. A finishing heating system 110, for example, can provide a warming heating experience to a food product and then before pick-up or delivery provide a finishing heating experience so that the food product is hot and fresh at the time of delivery or pick-up. The food packaging 108 may include one or more heating elements 109 to assist in generating and distributing heat across the food product. For example, a variety of food packaging with different configurations are described in U.S. Patent Application No. 62/864,525, entitled “Multi-dimension Heated Packages and Vessels”, to Baarman et al., filed on Jun. 21, 2019, which is hereby incorporated by reference in its entirety. One or more heating elements 109 in the food packaging assist in the ability of the intelligent heating system 100 to control the food product heating properties to both warm the food product during a storage period and then heat or finish the food product just before pick up or delivery to increase the enjoyment of the consumption experience, for example by improving the flavor, temperature, and/or freshness of the food product relative to conventional warming systems.

In one embodiment, the intelligent heating system 100 can simultaneously manage different heating experiences for multiple food products that can each be part of one or more pick-up and/or delivery orders. The timing and control of the heating experience can be enhanced by the intelligence of the system (e.g., various sensor output, RFID or other communication received/interrogated by the intelligent heating system) including information received from each food package 108 and remote devices 106, and the control of the energy transfer system 122 or heating electronics. The finishing system 110 can be installed at the point of sale or within a delivery vehicle. The system 110 can receive information from an order system 102 about each order and as food products for the order are filled, that food product can be linked to the pick-up or delivery order. For example, the finishing system 110 can provide instructions or an alert to the user of where to put the food in the finishing system 110. Alternatively, the user can select any open compartment to put the food order and an RFID system or other identification system can identify where the food was placed. The finishing system can receive preprogrammed temperatures/operational parameters or look up temperatures/operational parameters from a database, based on an ID tag 124 from a food package or other information. That information can include or be used to derive or obtain storage times/temperatures, finishing times/temperatures for pick-up and/or delivery food products, or other heating profile information or heating experience information.

The food package 108 may include an ID tag 124 and one or more sensors 126 that provide feedback to a controller of the intelligent heating system 100, such as the finishing heating system controller 118. Energy consumption can be reduced by intelligently controlling the finishing system 110 by controlling the heating experience based on collected information, such as pick-up customer location or delivery driver location information managed/collected by the location system 103, allowing the system to avoid or reduce energy expended above and beyond the energy to cook the food product. This intelligent control effectively reduces overcooking and assists in providing appropriately cooked food at the time of delivery and pick up. The intelligent heating system 100 can utilize sensor feedback from various sensors 114, 126 to control the temperature of the food product/package to prevent or reduce condensation from forming on the internal surfaces of the food package. The intelligent heating system 100 can manage the sequencing of the heating experiences over time and per order. The intelligent heating system can indicate which packages are included in each order. This information can be displayed locally on an intelligent heating system interface 101, remotely on a device interface 140, but also uploaded to a cloud database in real time so that the pick-up/delivery service experience can be tracked and improved through analytics.

Heating “experience” generally refers to the heating process undergone by a package and/or package contents during a heating operation. The heating experience can be provided according to a heating profile, which correlates operating parameters of the intelligent heating system and temporal information. For example, a heating profile, can define a set of operating parameters (e.g., characteristics of power such current, voltage, duty cycle, and frequency) of the energy transfer system and conditions for application of those characteristics, such as based on temperature feedback or timing information. A warming experience and finishing experience are two exemplary types of heating experiences that one embodiment of the present invention can provide. The warming experience generally refers to heating the food package and contents in such a manner so as to at least maintain its temperature, but also may continue the cooking process, typically at a reduced rate. The finishing heating experience generally refers to heating the food package and contents in such a manner so as to complete or finish the cooking process. This can include providing elevated temperatures relative to those during the warming experience. For example, the finishing temperature can ensure that the food is hot and fresh upon pick-up or delivery. In addition, the finishing temperature provided may enhance other characteristics of the food such as the crispiness or overall appearance of the food product.

The heating experiences provided by the intelligent heating system can be provided according to a heating profile. The heating profile can define operational parameters for the finishing heating system 110, such as timing values, current values, voltage values, wattage, joules, duty cycle, and essentially any other operational parameter that can be adjusted on the energy transfer system to affect the heating experience of the food product. For example, a delivery of steamed rice may be desired, where the steaming of the rice is started at a restaurant within a package with a target temperature of 100° C., then cooking is continued within the delivery appliance (e.g., finishing heating system) while the food is in route. The initial cooking system can be configured to cook the rice for a duration of heating within the restaurant by subtracting the estimated transit time to the delivery location (e.g., based on route information provided from route planning software) from the overall cooking time. Once the steaming or cooking process is completed either in route or within the customers home when the customer has a companion heated package appliance, the appliance may switch to the heating mode, keeping the rice above 75° C. to prevent food from being delivered cold, and to prevent condensation from forming within the package. For example, a companion heated package appliance such as the smart appliance disclosed in U.S. application Ser. No. 15/939,203, entitled “Smart appliances, systems and methods”, filed on Mar. 28, 2018 to Clark et al., which is hereby incorporated by reference in its entirety. The terms “smart” or “intelligent” as used herein may refer to information storage, processing, and communication features and capabilities that enhance operation and enable interfacing with users and with other devices, such as smartphones or external computers. It is worth noting that FIG. 1 illustrates several memory components within several of the systems to aid in explanation, it should be understood that a shared memory could be utilized for the intelligent heating system 100 and that memory may be included with or available to essentially any of the components in the intelligent heating system 100. There may be additional memory components located throughout the system, for example the device 106 may have memory and the food packaging 18 may have memory other than the memory associated with the ID tag and any memory associated with the sensors 126.

In one embodiment shown in FIG. 1, the present invention may include an intelligent heating system 100, device 106, and food packaging 108. The intelligent heating system 100 can include an order system 102, location system 103, a cooking system 104, and a communication system 107. Although the food package 108 and device 106 are represented outside of the intelligent heating system 100, they may also be considered a part of the intelligent heating system 100. It is worth noting that the system is described as a set of different components and systems in order to facilitate explanation, however, a person of ordinary skill in the art would appreciate that the system designations are somewhat arbitrary and the present invention is not limited by these categorizations, labels, and groupings. For example, the intelligent heating system 100 may include a different set of electronics that can perform the various functions of the system as opposed to multiple controllers and sub-systems depicted in the FIG. 1 embodiment. Further, some depicted components may be consolidated into a fewer number of components, or even a single component, that can provide the functionality of the depicted components, such as the various controllers included within the intelligent heating system 100. Similarly, some depicted components may be split into multiple components to provide similar functionality. For example, communication system 107 is depicted generally for receiving/transmitting communication to/from the intelligent heating system 100, however, individual systems may each have their own communication system instead of utilizing a single communication system for the intelligent heating system as a whole.

Via an order system, a specific order can be placed and each package in the order can be identified and linked back to the intelligent heating system 100. Using RFID tags of each package, every order can be tracked through fulfillment and can be fully verified to assist with order accuracy. In one embodiment, the order system writes the order ID on to an RFID associated with the food package. The order ID can be multiple portions, one portion indicative of the order and another portion indicative of the specific food product of that order. Alternatively, the RFID tag of the food product in which the food product will be placed once initially cooked can be brought in proximity of the order system so that the RFID tag can be interrogated and the unique ID number can be associated with the order in the order system. Further, the restaurant or merchant can have a record of each order, and as the food products are cooked and packaged that element of the order can be associated to a corresponding pick-up or delivery. One embodiment of an order system 102 is an electronic system that can collect and track customer pick-up and/or delivery food orders. The depicted embodiment of the order system 102 includes a controller 128 and memory 132. The order system 102 can be a generally conventional order system and therefore will not be described in detail. Suffice it to say, the order system 102 can be configured to accept customer orders via an electronic application from a customer device, such as via interface 140 of remote device 106, or via manual input from personnel at the point of sale that receive a food order from a customer, for example by voice over the phone and input via interface 101. The order system 102 can collect various order information from customers that can be utilized to prepare and fulfill the customers' food orders. The order information may include information about various food products being ordered and also an indication about whether the customer would like the food order for delivery or pick-up. The order information can include multiple menu item selections. For deliveries, the order information may also include delivery information, such as a delivery location to which the order should be delivered. The order information, including the delivery location information can be stored in memory 132 associated with an order ID assigned for that customer's order.

The location system 103 can track the location and estimated arrival time of customers for pick-up orders and/or the location and estimated arrival time of delivery vehicles to the delivery locations. The location system 103 can include a routing system 130 with a controller 134 and memory 135 for determining a delivery route for delivery orders and can also include a tracking system 131 with a controller 136 and memory 137 for tracking customers estimated time of arrival for pick-up orders. If the intelligent heating system is only being utilized for delivery service, the tracking system need not be included and if the intelligent heating system is only being utilized for pick-up service, the routing system need not be included. The location system 103 can receive, directly or indirectly from a device 106, location information, which can be stored in memory 135, 137. The location information can include a variety of different information about the location of a customer as they travel toward the point of sale to pick-up their order or information about the location of a delivery vehicle as it travels toward one or more delivery destinations to deliver orders to customers. The location information received by the location system 103 can include estimated time of arrival information, speed information, distance information, geolocation information, global positioning system information, or essentially any other location information that is indicative of the location of a customer or delivery vehicle or that can be utilized to derive the location or estimated time of arrival of the customer or delivery vehicle. The location information can be received periodically, for example via a communication channel between a device 106 and the intelligent heating system communication system 107. Further, the location system 103 can communicate location information or information derived from the location information to the cooking system 104. The intelligent heating system 100 can utilize the information to automatically control the energy transfer system by adjusting the energy transfer system 122 between providing different heating experiences based on the location information. For example, the information can be utilized to provide a warming heating experience and a finishing heating experience based on the location information from the remote device 106 indicative of the estimated time of arrival of the customer or the estimated time of arrival of the delivery vehicle to the scheduled delivery locations.

To enable the proper timing and temperature over the appropriate time the intelligent heating system can utilize location information, such as the delivery schedule and the customer location. This can be done through a mobile application, either on the customer's device 106 or delivery driver's device 106. Radio location information provided by a radio location system 142, such as radio telemetry or global positioning system (GPS) can include locations and speed information that can be used to determine energy and temperature targets for storage, and also energy and temperature targets for finishing heating for final delivery that prevent over cooking.

One embodiment of the intelligent heating system includes an order system configured to receive a food order including a food product, an initial cooking system configured to partially cook the food item a communication system for receiving location information from a remote device, and a finishing heating system including an energy transfer system, where the control system is configured to selectively control the energy transfer system to finish cooking the partially cooked food item in response to the location information.

For food pick-up service applications, the communication system periodically receives location information from the remote device indicative of a current location of the customer. The control system is configured to automatically control the energy transfer system by adjusting the energy transfer system between providing a warming heating experience and a finishing heating experience to the partially cooked food item based on the location information from the remote device indicative of the current location of the customer. The adjustments can, for example, be adjustments to a characteristic of power applied to an inductive heating coil, such as voltage, current, power, phase, duty cycle, or some other characteristic that results in a change in the amount of energy/heat received by the food product. The control system can be configured to selectively control the energy transfer system to provide a warming heating experience while the distance between the current location of the customer and the intelligent heating system is greater than a predetermined distance. Further, the control system can be configured to automatically control the energy transfer system to provide a finishing heating experience to the partially cooked food item while the distance between the current location of the customer and the intelligent heating system is less than the predetermined distance. Instead of using distance as a trigger for switching heating experience, the system can utilize other types of location information, such as estimated time of arrival. For example, the location information can include information indicative of an estimated time of arrival of the customer and the control system can be configured to automatically control the energy transfer system by adjusting the energy transfer system between providing a warming heating experience and a finishing heating experience to the partially cooked food item based on the information indicative of the estimated time of arrival of the customer. Further, the control system can be configured to automatically control the energy transfer system to provide a finishing heating experience to the partially cooked food item in response to a difference between an amount of time to complete the finishing heating experience and the estimated time of arrival of the customer being below a pre-determined threshold. That is, as the customer's arrival time comes closer, the system can monitor the arrival time and based on the amount of time to finish the cooking process for a food item, the finishing process can be started so that the food will finish cooking at or just before the time the customer arrives. The heating experience provided during the finishing heating experience can be static once the customer crosses a threshold distance or ETA, or alternatively, the system can continue to monitor the customer's ETA or distance and continue to adjust the heating experience accordingly. For example, if the customer's ETA changes (for example, the customer makes a stop, a wrong turn, or traffic congestion forms), the finishing heating experience can be adjusted to stretch out the cooking time so that the cook finishes about the time the customer will arrive. If the ETA or distance and speed changes significantly such that the arrival time is above the finishing threshold, the control system can switch back to providing a heating experience until the arrival time is once again below the finishing threshold.

For food delivery service applications, the intelligent heating system can receive or obtain (for example by look-up or prior engagement) a delivery destination stored in memory. The communication system can also periodically receive location information from a remote device indicative of a current location of a delivery vehicle (for example, the delivery vehicle itself can have a radio location system or alternatively the delivery driver can have a device with a radio location system). The control system can be configured to automatically control the energy transfer system by adjusting the energy transfer system between providing a warming heating experience and a finishing heating experience to the partially cooked food item based on distance between the delivery destination and the current location of the delivery vehicle. Alternatively, the adjustment can be based on other location information, such as the estimated time of arrival of the delivery vehicle at the delivery destination stored in memory. Similar to with the pick-up experience described above, the control system can be configured to automatically control the energy transfer system to provide a finishing heating experience to the partially cooked food item in response to a difference between an amount of time to complete the finishing heating experience and the estimated time of arrival of the delivery vehicle being below a pre-determined threshold. The intelligent heating system can also include an order system configured to receive multiple food orders that each include a delivery destination and one or more food items. The initial cooking system can be configured to partially cook each of the one or more food items in each of the food orders. The intelligent heating system can also include a routing system for determining a delivery route for delivering the plurality of food orders. The control system can be configured to automatically control the energy transfer system by adjusting the energy transfer system between providing a warming heating experience and a finishing heating experience for each of the food orders based on the delivery route and the current location of the delivery vehicle.

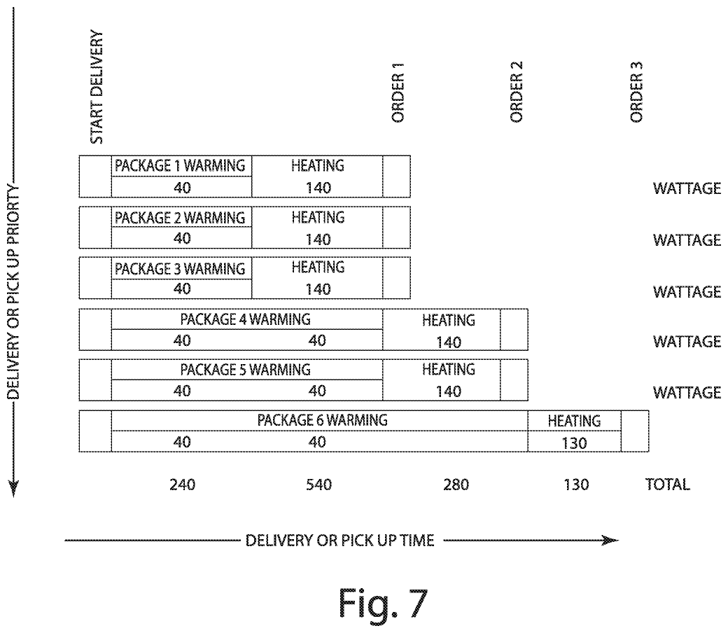

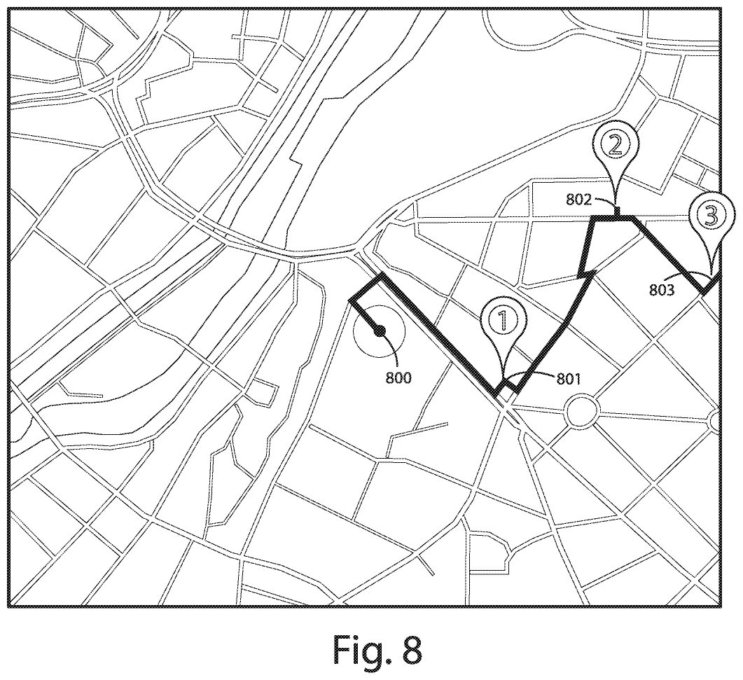

For delivery orders, the location system 103 may include a routing system 130 that can determine a delivery route for a delivery driver to deliver the food orders. FIG. 8 shows one example of a route map with a start location 800 and sequence of delivery locations 801, 802, 803 that can be generated by the routing system 130. The depicted sequence sets up the timing for each delivery point and can determine or obtain the amount of time between each delivery, which can be utilized to define the heating profile for each food product in each food order on the delivery schedule. While a delivery map is depicted to assist in understanding the functionality of the routing system 130, the routing system may provide address information, turn-by-turn instructions, or otherwise communicate a delivery route to a delivery vehicle or a delivery driver's device with or without providing a map. Further, the vehicle route can be updated in real-time if traffic or other driving conditions change by communication with the delivery vehicle, such as by a device 106. The routing system 130 can also define the heating profiles and timing for the energy transfer system as shown in FIG. 7 and described in more detail herein. FIG. 7 depicts a representative energy and timing graph that illustrates operation of the control system in terms of timing and heating energy for pick-up or delivery orders. The graph shows the resultant times and amount of energy applied to six food products organized in three orders. The food products are each warmed during a storage period where a warming heating experience is provided and finished during a finishing period where a finishing heating experience is provided. The heating experience algorithm can be a variable algorithm based on heating deltas and timing. The algorithm can use the total travel time for the delivery and the stops or segments required in the sequence expected. The power can be calculated serially for each segment while the other segments are warmed requiring much less power. This involves time to destination from the previous segment, how much energy is required for that time and how many items are being heated to define total power. If the available power is suitable for the system the system reports no errors and the delivery can be made. Essentially, this reduces the overall power to a segment worth of food cooking and not the total delivery route to be made. Each segment is then processed accordingly. Occasionally, there may be overlay where the next segment is close to the prior. The system can then overlap the timing by segment to allow that overlap in sequence in order to deliver the required heating. Each food package can include information about the food contained within and information about the packaging, such as package type. The power and temperature can be controlled in cycles and controlled to provide a target temperature at pick-up or delivery and controlled to provide a different target temperature during storage where the temperature is optimized to prevent overcooking while keeping the food warm.

The delivery route can be generated in accordance with a food delivery route planning system. Food delivery route planning software is generally well known and therefore will not be described in detail. However, known food delivery route planning software does not factor in the time the food is in the delivery vehicle or the associated status of the food. That is, all delivery orders are generally treated equally with no weight given to the content of the different delivery orders or the power consumption of any heating system installed in the vehicle. Certain embodiments of the present invention can utilize known route planning software, while other embodiments can utilize route planning software that factors in additional considerations available to the intelligent heating system, such as the relative expected heating experiences of the food products in each order and the power consumption of the finishing heating system installed in the vehicle. For example, a typical route planning software may plan a route based on minimal travel time, however this route may be adjusted to account for known cooking times, such that food with the shortest cooking time is delivered first even if it is further from other food deliveries, thus allowing foods with longer cook times to be delivered later.

There are a number of considerations that can be considered by a route planning system 130 including, weather conditions, road construction, and traffic congestion. Route planning software can generate a delivery route including turn-by-turn instructions for a delivery driver to guide the delivery driver from the point of sale to each delivery destination. At the time of planning, estimated times between each delivery can be calculated and utilized to inform how the energy transfer system is configured to warm and heat the packages.

An exemplary route generated by one embodiment of the route planning system will now be discussed in connection with FIGS. 7 and 8. In this example, there are three deliveries being made from a restaurant 800 to the first delivery location 801, second delivery location 802, and third delivery location 803. The route planning system can calculate a variety of different potential routes utilizing a number of well-known route planning algorithms. The route planning system provides a route that will take about 10 minutes to reach the first delivery location, 7 minutes to reach the second delivery location from the first, and another 4 minutes to reach the third and final delivery destination. The route planning system may include estimates for the time it takes the delivery driver to approach the residence and deliver the food products for the order. The route planning system also works in conjunction with the power management system described earlier to assure time to cook is being met and proper power levels are available from the system, i.e., too many trips within 2 minutes (not providing time to cook), etc. Further, while the route planning system can generate the route one time at the outset and the energy transfer system can act accordingly, in some embodiments the route planning system can be updated in real-time as the situation in the field changes. For example, if a delivery takes additional time or the traffic congestion changes, the routing can be changed and the finishing heating system can be instructed to change the heating experiences of the onboard food products accordingly.

Referring to FIG. 7, during operation the energy transfer system initially provides a warming experience to all six food packages in the finishing system. In the depicted embodiment the warming heating experience is produced by applying about 40 joules of energy to each food package. When the delivery driver is about 5 minutes away from the delivery destination, the energy transfer system is adjusted to provide a finishing heating experience to the three food packages in the first order. In the depicted embodiment this is accomplished by applying about 140 joules energy to each food package for a period of time of about 5 minutes. The other three food packages continue to be provided with a warming heating experience because their delivery destination is not imminent. The energy transfer system 122 can follow the schedule provided by the routing system 130 and adjust the heating experience for the next two packages that are part of the second order to provide a finishing heating experience. Although the depicted graph shows this finishing heating experience beginning at about the time of the first delivery, in alternative routes with different timings, the finishing heating experience may begin later or earlier. For example, the finishing heating experience could be started before the first order is even delivered. It is worth noting that the routing system may consider the heating experiences being provided and then specifically schedule a route that reduces the amount of time that certain heating experiences are simultaneously provided to multiple food products. That is, the routing system 130 can factor into its route planning how many food items are to be provided finishing heating experiences simultaneously, which typically require more energy than providing warming heating experiences. It can be beneficial for vehicle power to reduce the spikes of power consumption. By factoring this into the routing it can help to ensure a more even power consumption over the delivery service. Finally, the third order can be provided a finishing heating experience and delivered to the third delivery destination. As depicted in FIG. 7, all food products need not be provided with the same amount of energy during their warming and heating experiences. For example, the third order is only heated using 130 joules of energy whereas the other two orders utilize a 140 joule finishing heating experience.

The routing system 130 can factor in the different food products that are included in each order and in some circumstances adjust the route or sequence of delivery accordingly. For example, even if the most efficient/shortest delivery route is to deliver orders in the sequence of order 1, order 3, order 2, the routing system may determine that the overall freshness and flavor of the food will be enhanced by delivering the orders in the order of order 2, order 3, then order 1. This can be due to a variety of different factors. For example, some food items may respond better to longer warming experiences withstanding longer storage periods in the delivery vehicle. Other food items may be particularly difficult to keep warm and benefit from reducing the amount of storage time in the delivery vehicle.

For pick-up orders, the location system 103 may also include a tracking system 131 that can determine estimated time of arrival of customers to pick-up their orders. The location system 103 can receive, directly or indirectly, from a consumer's mobile device 106 via the communication system 107, location information that can be utilized by the intelligent heating system 100. The location information can include information about the customer's estimated time of arrival, location, distance, speed, and/or any other information that can be utilized to derive estimated time of arrival information. The energy transfer system 122 can be used to provide heating experiences for the food orders during a storage period while the customers are traveling to pick-up the food orders. Before the customer reaches the store, the intelligent heating system 100 can change the heating experience to a finishing heating experience to heat the food products in the customer's order to the appropriate pick-up temperature and create a better consumption experience.

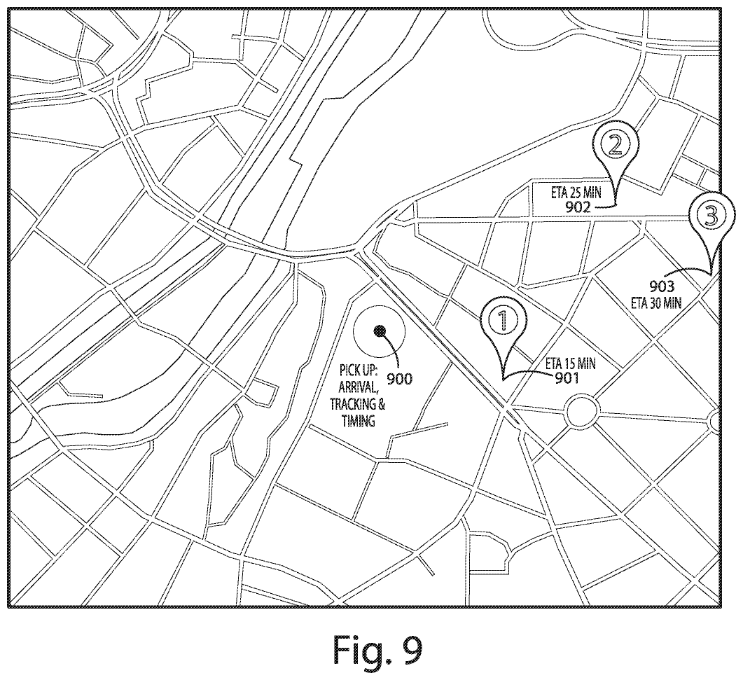

To aid in explanation of the tracking system, FIG. 9 shows one example of a map with estimated time of arrival information for three customers. Each customer with an active pick-up order can have their mobile device 106 report an estimated time of arrival (or other location information) to the intelligent heating system 100 so that the pick-up order can be heated intelligently. For example, referring to FIG. 9, the first customer 901 for pick-up order 1 is about 15 minutes away from the restaurant 900; the second customer 902 for pick-up order 2 is about 25 minutes away; and the third customer 903 for pick-up order 3 is about 30 minutes away. These estimates can be provided automatically by the same application used to place the food order or in another manner. Further, the estimated times can be updated periodically. The depicted sequence sets up the timing for each pick-up, which can be utilized to define the heating profile for each food product in each food order. While a map is depicted to assist in understanding the functionality of the tracking system 131, the tracking system 131 may not include any visual representation of the customers' positions but instead merely adjust operational parameters of the energy transfer system 122 according to the estimated times of arrival. The tracking system 131 may simply receive estimated time of arrival information from each customer device, but it may instead or in addition receive distance, speed, or other location information, which can be utilized to derive the customers time of arrival. For example, the tracking system 131 can factor in additional information such as road maps, speed limits, weather, prior pick-up order timing, or any other factors that can affect the pick-up customer's estimated time of arrival. The tracking system can set or adjust the heating profiles and timing for the energy transfer system as shown in FIG. 7 and described in more detail herein.

Referring to FIG. 7 with respect to pick-up orders, during operation the energy transfer system initially provides a warming experience to all six food packages in the finishing system. In the depicted embodiment the warming heating experience is produced by applying about 40 joules of energy to each food package. When the customer is about 5 minutes away from the storefront, the energy transfer system can be adjusted to provide a finishing or heating experience to the three food packages in the first order. In the depicted embodiment this is accomplished by applying about 140 joules energy to each food package for a period of time of about 5 minutes. The other three food packages in the remaining two orders continue to be provided a warming experience because their customer's arrival is not imminent. The energy transfer system can follow the schedule provided by the tracking system and adjust the heating experience provided by the energy transfer system for the next two packages that are part of the second order to provide a finishing heating experience in response to that customer's arrival. Specifically, the customer's mobile device application can provide location information to the intelligent heating system, which can be configured to automatically control the energy transfer system to provide a finishing heating experience in response to a difference between an amount of time to complete the finishing heating experience and the estimated time of arrival of the customer being below a pre-determined threshold.

Although the depicted graph shows this heating experience change occurring about the time that the first customer picked up their order, the pick-up order heating experience is not dependent on the pick-up order arrival times. That is, all of the customers could arrive at about the same time and the orders could follow a similar progression of heating experiences. As depicted in FIG. 7, all food products need not be provided with the same amount of energy during their warming and heating experiences. For example, the third order is only heated using 130 joules of energy, as opposed to the 140 joules used to provide a finishing heating experience to the first two orders.

Whether dealing with pick-up or delivery orders, it is worth noting that all food products in an order need not be provided the same warming/heating experience. That is, although each food product in orders 1 and 2 receive the same warming and heating experience, in alternative embodiments the heating experience may be different among food products in an order. For example, certain food products may have different pick-up temperatures that enhance the consumption experience. These temperatures can be configured into the intelligent heating system. In addition, a heating experience need not be uniform. Although for ease of explanation the heating experiences shown in the FIG. 7 graph involve a uniform energy transfer of 40, 130, or 140 joules. Heating experiences can be more complex than that. For example, the heating profile for a warming profile may include a variable amount of joules that fluctuates between two different values. Alternatively, the energy transfer system may have a spatial aspect to the energy delivery where a lower (or higher) amount of energy is provided to the edge of the food product while a higher (or lower) amount of energy is provided toward the center of the food product.

The cooking system 104 can include an initial heating system 105 and a secondary or finishing heating system 110. The initial heating system 105 and the finishing heating system 110 cooperate to provide cooked food that fulfills customers' orders.

The initial heating system 105 is configured to initially cook the food product. For example, the initial heating system 105 can be a conventional oven or other heating appliance that is used to cook food products in the pick-up and delivery service industries. In one embodiment, the initial heating system 105 is a pizza oven or grill. The initial heating system 105 can be a smart appliance that can communicate with other components of the intelligent heating system 100. For example, the initial heating system 105 may receive order information from the order system 102, which can be used to adjust heating characteristics, timing, and to assist with order identification. In addition, the initial heating system 105 may receive location information from the location system, such as routing information related to delivery orders or tracking information related to pick-up orders. Alternatively, the initial heating system 105 may not have any smart capabilities and may merely be utilized to provide an initial cook to the food. Once the food is cooked to the desired doneness, the food can be removed from the initial heating system 105 and placed in food packaging 108 and placed in the finishing heating system 110.

In one embodiment, the initial heating system 105 is configured to partially cook food products so that the cooking process can be completed in the finishing heating system 110. By partially cooking a food product and finishing it with the finishing system 110, the intelligent heating system 100 can provide food products that are cooked just-in-time—that is, because the system knows when the customer will be receiving the food (either by pick-up or delivery) the cooking time can be adjusted so that the cooking process finishes near that time. For example, the initial heating system 105 can be configured to partially cook food to about 80% done so that the finishing system 110 can complete the cooking process based on the delivery or pick-up schedule to provide on demand cooked food. That is, the intelligent heating system 100 can provide an indication for a worker to remove the food product from the initial heating system 105 and then move it to the finishing heating system 110 before the cooking process is complete so that the warming/heating experiences provided during the finishing heating system 110 complete the cooking process over time instead of re-heating or maintaining temperature, which can degrade the flavor and freshness of the food. In embodiments where the initial heating system 105 has smart capabilities, the intelligent heating system 100 may instruct the initial heating system 105 to automatically to turn off or otherwise control the initial heating system 105. The initial heating system 105 can be configured to handle different food products differently. For example, one food product may be better suited to be cooked to about 80% done in the initial heating system 105 while a different food product may be better suited to be cooked to about 70% doneness in the initial heating system 105. In addition, the amount of time and operational parameters of the initial heating system 105 can be set or adjusted based on the location information provided by the location system 103.

Put another way, the intelligent heating system 100 can substantially delay, push back, or spread out the complete cooking or heating time of the prepared food. Each food item can include a heating profile for reaching a proper doneness at the time of consumption. The heating profile may be broken down into separate portions, for example an initial heating portion and a finishing portion. The initial heating portion can include being cooked in a conventional oven and may or may not include a warming portion. The primary difference between the initial heating portion and the finishing portions is that the initial heating portion is doing the bulk of the actual cooking of the food item, and may include maintaining the warmth of the food or cooking the food slowly at a lower temperature to ensure the initial heating portion completes on an appropriate time table based on the information available to the intelligent heating system 100. Each portion of the heating profile can include time and temperature information. For example, the food can be initially cooked and then fully cooked just before pick-up or delivery for an optimal consumption experience. Alternatively, the food can be fully cooked once the customer's order has been received, and then maintained at a warm temperature until pick-up or delivery. In delivery embodiments, the cooking portion of the heating profile can be conducted during delivery, remotely from the actual restaurant or merchant itself.

Using an example, where the order system has fifteen active delivery orders, the intelligent heating system 100 can determine the number of deliveries to include in each batch delivery for a delivery driver along with the settings for the initial heating system 105 and finishing heating system 110. Continuing with this example, four delivery locations may be near each other and about 15 minutes from the storefront. However, one of those four orders may have been received about 10 minutes later than the other three. Ordinarily in this situation, either the fourth order would need to be sent out with a separate delivery vehicle, or the delivery vehicle would need to wait for the fourth order to cook before leaving with all four orders. In one embodiment of the present invention, all four orders can be delivered by a single delivery vehicle. The fourth order is partially cooked in the initial heating system 105 and the intelligent heating system 100 manages the settings and timings of the initial heating system 105 and finishing heating system 110 in order to ensure all four food items are fully cooked by the time they are delivered. This can be accomplished by providing an increased amount of energy during travel to the fourth order that was moved to the finishing system 110 earlier than the other orders in order to enable the delivery driver to leave the storefront sooner. Alternatively, the delivery route can be scheduled such that the fourth order is delivered last so that there is more time in the finishing heating system 110 to complete the cooking process. Ultimately, this management of orders by the intelligent heating system 100 provides more efficient delivery service.

The finishing heating system 110 provides heating experiences to food products. For example, the finishing heating system 110 can be configured to provide warming heating experiences and finishing heating experiences. The finishing heating system 110 of FIG. 1 includes a power management system 112, a sensor system 114, a controller 118, an identification system 120, an energy transfer system 122, and memory 123. The power management system 112 can manage the power for the system. The sensor system 114 can include a variety of different sensors that provide feedback for the controller 118 in order to execute a variety of different control methodologies. An identification system 120 can be part of the sensor system or a separate system entirely. For example, in one embodiment, the identification system 120 is an RFID reader that can read RFID tags associated with food product packaging or containers. The controller 118 can control the energy transfer system 122 in order to provide desired heating experiences to food packaging 108 and their contents—the heating experience can be informed by the sensor system 114 and the identification system 120. Various information can be stored in memory 123 including location information, ID information, heating profile information, and essentially any other information applicable to providing desired heating experiences to food packaging 108.

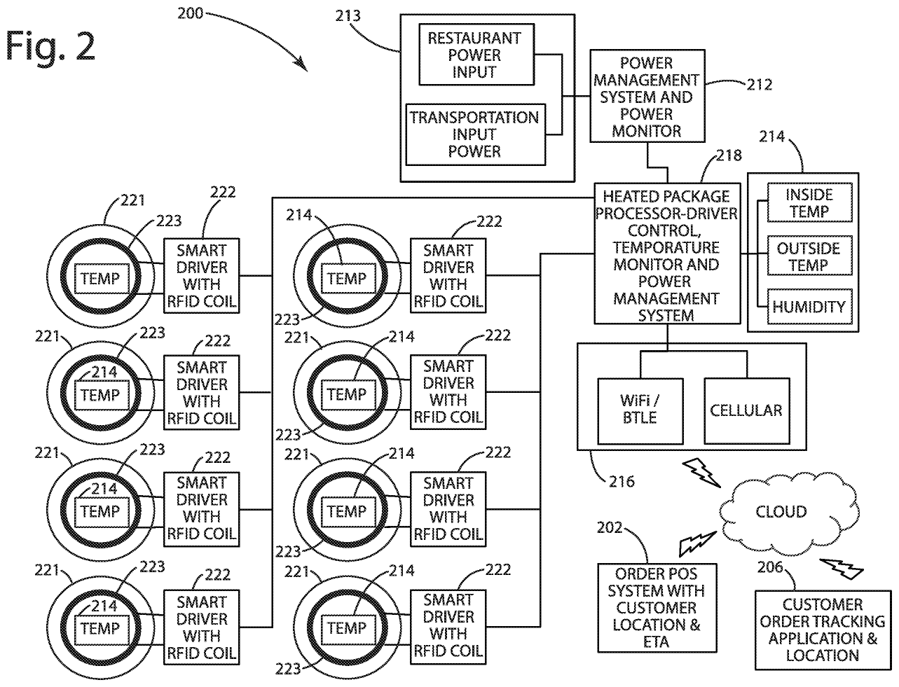

FIG. 2 illustrates one embodiment of a finishing heating system 200. The finishing heating system 200 or package heating system tracks customers coming to the storefront to pick-up orders and can also tracks delivery vehicles/drivers in order to optimize the energy and experience of the packaged food 108.

The finishing heating system includes a power management system 212. The power management system can manage and sequences power to reduce or minimize input power. In one embodiment the system can be configured to accept 12VDC to 48VDC or for buildings 120-240VAC input. The power management system can accept a power input 213. In the illustrated embodiment, the power management system 212 is configured to accept standard wall power, such as a restaurant power input 213 and also transportation input power 213 that is available in a vehicle. In alternative embodiments, only one input power is available depending on whether the system is being installed at a point of sale or within a delivery vehicle. The power management system 212 can also include a power monitor that can be utilized to track the amount of power consumption for analytic purposes. In some embodiments, the power consumption information can be utilized to control the energy transfer system. For example, the power monitor can be utilized to provide feedback about total power consumption and avoid power consumption spikes. The power management system 212 can provide power for the various electronics throughout the finishing heating system, and in some embodiments to various components within the intelligent heating system at large. The power management system 212 can also provide the energy to the energy transfer system for ultimately heating the food products and packaging 108.

The finishing heating system includes a controller or heated package processor 218. The processor can include a driver control, temperature monitor. The power management system, or a portion thereof, can be integrated into the heated package processor 218. The circuit 218 can include a variety of sensors 214, such as an inside temperature sensor, outside temperature sensor, and a humidity sensor. A temperature sensor 214 can also be provided in proximity of the food product, either within the finishing system or on the food packaging. The inside temperature sensor 214 can measure the ambient temperature within the immediate proximity of the finishing system 200, for example by routing a probe to an external surface of the housing of the system 200. The outside temperature sensor can measure or obtain the outside temperature. The humidity sensor can measure or obtain the humidity level. The sensor can obtain the humidity information from an external source or alternative measure the humidity level with a humidity sensor disposed on or in proximity of the finishing heating system. One example of a humidity sensor is a hygrometer that measures the amount of humidity and water vapor. The humidity sensor can also measure the temperature of condensation, sometimes referred to as dew point, or changes in electrical capacitance or resistance to measure humidity differences. The inside temperature and food temperatures can be recorded and used to maintain ideal storage temperatures. The humidity can be calculated and used to control the heating provided to assure food/package temperatures reduce, minimize or prevent condensation from forming.

The finishing system can also include a communication system 216. The system can have WiFi or cellular service for retail or delivery options. For example, the communication system 216 can include WiFi and/or Bluetooth Low Energy (BTLE) modules to communicate to/from the finishing system 200. The BTLE can provide an interface for the driver or service person providing notifications as the pick-up or delivery is about to happen or if any issues have occurred. The communication system 216 can also include a cellular communication module that enables cellular communication. The communication system 216 can be the communication system 107 that handles communication for the entire intelligent heating system 100, or a separate communication system that handles communication only for the finishing heating system 110. The communication system 216 can be utilized to communicate over the Internet or a local network. For example, the communication system 216 can enable communication with an order system 202 that includes customer location information and estimated time of arrival information. The communication system 216 can also enable communication with a tracking system 206, such as a customer order tracking application that can provide real-time location information. Communication with these systems can supplement or replace interaction with other systems such as the location system 103 and the order system 100. The cloud interface can enable route linkage, the ability to verify delivery status and provide point of sale linkage and sales information. The communication system 216 can also enable communication with an order system such that food packages can be verified and food orders can be connected for the service or delivery personnel.

The finishing system can include a plurality of compartments for placing different food products. The system can be configured as a cabinet or rack 600, for example as depicted in FIG. 6. Each compartment 602, bay, or slot of the cabinet can include a separate heating coil 223, RFID coil 221, temperature sensor 214, and smart driver with RFID reader 222. The heated package processor 218 can communicate with and control the smart driver with the RFID reader 222 and temperature sensor 214.

The finishing heating system 200 can be integrated into a rack or cabinet that includes multiple compartments, such as inductive rack 600. Referring to FIG. 6, a representative illustration of one embodiment of an inductive rack 600 finishing heating system is illustrated. In one embodiment, the rack includes LED indicators 606 for providing intelligent lighting. In addition, the rack is configured with sensors that can track when products are placed and removed from the rack and be added to a pick-up or delivery order. In the depicted embodiment, the storage and heating rack 600 is a cabinet for heating and storing food and includes one or more bays 602. In the example shown, the rack 600 includes multiple columns and rows of open bays 602, each of which include a support surface 604, at least one induction heating coil 623, and a driver/RFID reader 622 with an RFID coil. The RFID reader 622 and coil can interrogate an RFID tag 624 located on the food package 608 to obtain an ID that can be utilized to look up order information, location information, or other information available to the intelligent heating system based on the package ID. Alternatively, the ID tag can include order information, location information itself that is directly provided from the RFID tag to the reader upon interrogation. Each bay 602 is sized to house and heat one or more smart packages 608 and may be in communication with the controller 218 via wire or a wireless communication system. Further, each bay 602 may include an RFID reader 622 for tracking the packages 608 placed within the heating rack 600. The controller 218 can control the smart driver 622 to control the heating experience provided to each food product in each bay of the heating rack by energizing the induction heating coil 604 in each bay 602. Different heating experiences can be provided according to different heating profiles by controlling the various operating parameters, such as voltage, current, duty cycle, phase, or essentially any other operational parameter of the energy provided from the smart driver to the induction heating coil 604. As discussed herein, the heating rack 600 can be used in a retail setting for warming pick-up orders or in a delivery vehicle for food delivery service.

The heating rack 600 can be in communication with the controller 218 to appropriately control the heating experience for each bay. Specifically, the controller can energize the induction heating coils 623 to control the temperature and timing for each bay 602 such that the package 608 is provided the appropriate heating experience at the proper time. For example, the food can be warmed for storage within the heating rack 600 and then the food can be heated to the consumption temperature just before pick-up or delivery to provide an optimal consumption experience. The timing and control of this can be enhanced by the intelligence of each package 608 and the connection to the controller 218 or other components of the intelligent heating system.

The heating rack 600 can include other intelligent features such as controlled lighting or other indicators and alerts. In the depicted embodiment, each compartment may include one or more LED lights 606 for indicating particular characteristics about the compartment 602 and/or package 608 housed within the compartment. For example, colored lighting can color coordinate the different food packages into groups of orders. For example, three compartments can be lit with a blue light to indicate the food products in those three compartments belong to the same order while two other compartments can be lit with a red light to indicate those food products belong to a different order. Instead of color, the lighting could use brightness to group orders. This includes, condiments, napkins, silverware that can all be part of the experience and monitored accordingly for the overall experience. Or, in an alternative embodiment, a button on the rack can be activated to cycle between different orders, activating the lighting or other indication system in each compartment belonging to the current order. In yet another embodiment, the lighting system and RFID system can coordinate to assist in ensuring all items in a food order stay together. For example, when one food product belonging to an order is removed from the rack, the system can be configured to light up any other compartments with food orders belonging to the same order so that they can be gathered for pick-up or delivery.

The heating rack 600 can include a system interface 610 as well as an individual interfaces 612 associated with each compartment 602. Each interface can include a display and I/O. The interface can be utilized to manually indicate a food product is placed in a specific compartment (for example, by inputting an ID associated with the food product or food packaging) so that the intelligent heating system can provide the appropriate heating experience for that food product. The user interface can also display status information, for example after reading an ID tag of a food product set in a compartment, the current heating profile/experience and other information associated with that item can be displayed on the user interface. The heating rack 600 and/or intelligent heating system 100 as a whole can track when a package 608 is set within or removed from the heating rack 600 and added to the order for pick-up or delivery. A separate RFID reader may be used in a bagging area to read the RFID tags placed in the bag to assure the order is complete.

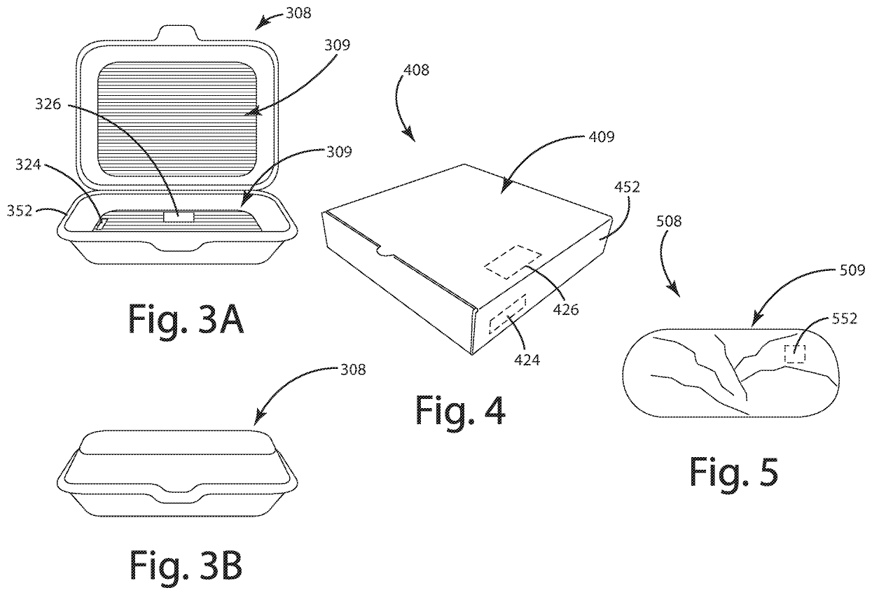

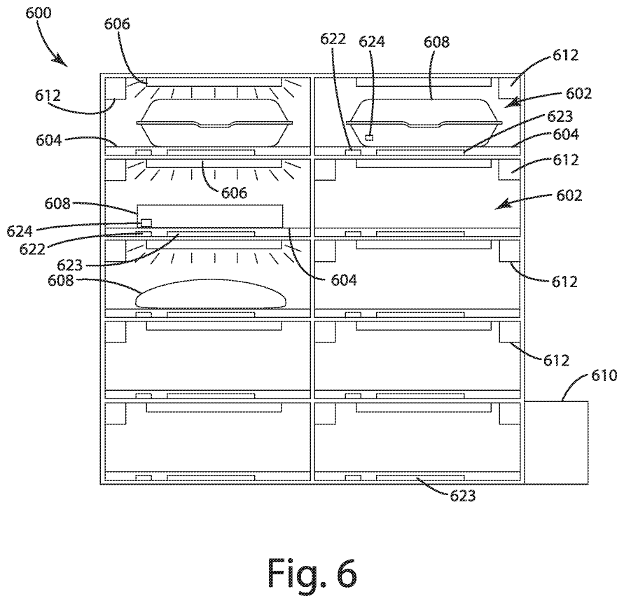

FIGS. 3A-B, FIG. 4, and FIG. 5 illustrate a variety of different packages for use with the intelligent heating system. The heatable packages can be designed for portability and heat retention. The depicted packages are inductively heatable portable containers. The packages 308, 408, 508 each include a container body 352, 452, 552 and can be in the form of a Styrofoam container, a cardboard pizza box style container, a foil wrap, box, pouch, bag, beverage container, soup container, or any other style container that food products may be stored and/or transported in. The package 308, 408, 508 can be any device having one or more walls forming an interior area for the food product. The packages can include an opening so that food items can be placed in the interior area, and the package may include multiple compartments or sections.

The package 308, 408, 508 may include a heating element, such an inductively heatable element, inductive receptor, resistive heater, or combination thereof. FIG. 3A and FIG. 4 illustrate food packages that include inductive traces 309, 310 that can interact with a magnetic field generated by an energy transfer system to enhance heating. When energized, the traces can produce heat. The amount and distribution of the heat is determined, at least in part, by the amount and characteristics of energy transferred as well as the physical position, shape, and other characteristics of the traces themselves. Suffice it to say, the physical heating properties can be adjusted by selecting an appropriate heat transfer element to install on the food package and/or by adjusting the energy transferred by the energy transfer system. For example, operating parameters for an inductive heating appliance and food packaging configurations are described in U.S. Patent Application No. 62/864,525, entitled “Multi-dimension Heated Packages and Vessels”, to Baarman et al., filed on Jun. 21, 2019, which is hereby incorporated by reference in its entirety and U.S. patent application Ser. No. 15/939,203, entitled “Smart Appliances, Systems, and Methods”, to Clark et al., filed on Mar. 28, 2018, which is hereby incorporated by reference in its entirety. FIG. 5 illustrates a food package that includes conductive material. In particular, the food packaging is a metal foil 509 that wraps around the food product assisting in retaining heat within the package. For example, a burrito or sandwich can be wrapped with foil wrapping. The foil wrapping may include an RFID tag or other inlay. Alternatively, the foil wrapping may not include any identification circuit, and instead the temperature of the foil wrapped food product can be monitored by correlating the compartment temperature where the foil wrapped product is stored. The energy transfer system can transfer energy to heat food product by heating the metal foil. The characteristics of energy transfer and the physical properties of the metal foil can be selected such that the energy heating system can provide multiple heating experiences to the food product contained within, such as a warming heating experience and a finishing heating experience. The package 508 may optionally include insulation.

Each package may be configured as a smart package that includes electronics for use in connection with the intelligent heating system. Some embodiments may include an ID tag, such as a radio-frequency identification (RFID) tag 324, 424 for identification and tracking of the food package. The RFID tag 324, 424 can be a machine-readable element that can store and transmit a unique identifier, such as an electronic serial number (ESN), that may be pre-associated with a particular package 324, 424. The RFID tag 324, 424 can, for example, communicate with the intelligent heating system 100, for example via an induction heating coil of an energy transfer system, an RFID reader, or other communication system. The RFID tag 324, 424 can be coupled to, attached to, formed on, integrated with, or otherwise joined with the package 308, 409 in a variety of positions and by a variety of methods. In the illustrated example, one RFID tag 324 is adhesively attached to the internal bottom surface of the package 308 while in the other package 409 the RFID tag 424 is adhesively attached to the external side surface of the package 408. The positioning of the RFID can be selected such that the RFID tag is in position to be read by an RFID reader when the package is inserted into a compartment of a finishing rack. The RFID tag enables the food package to be used for pick-up or delivery.

In addition to an ID tag, each food package may include one or more sensors. The food package embodiments of FIGS. 3A-B and FIG. 4 each include a temperature sensor 326, 426 for sensing temperature measurements of the food product or internal cavity of the food package. The temperature measurements can be communicated to a communication sub-system of the intelligent heating system directly from a communication enabled temperature sensor or via an RFID tag 324, 424 or other communication module installed on the package. The temperature sensor can be configured to periodically take temperature measurements and automatically communicate them to the intelligent heating system for use in its intelligent heating control algorithms, such as the method of condensation control described in more detail herein. The temperature readings may also be utilized to confirm and verify the heating experience generated by the finishing system. For example, the temperature sensor output can confirm the warming heating experience or finishing heating experience. The temperature sensor output may also be part of a feedback loop to provide those heating experiences, for example, where the temperature sensor output is feedback utilized in a proportional, integral, derivative loop, or other type of control loop, to reach a temperature set point during a certain heating experience. Further, certain heating experiences may be variable over time and heat according to a heating profile that involves providing a variable temperature to the food product over time. Further, additional temperature sensors may be provided in the packaging to assist in providing a more accurate temperature reading or as part of a system for providing different temperatures at different positions within the food product. For example, certain portions of the food package can be heated to different temperatures in order to provide different heating experiences or different heating profiles to different areas of the food package. The physical structure and material of the package can be configured to assist in providing these different heating experiences. For example, the package may include insulation, shielding, or energy guides to direct energy received at the package to assist in providing different locational-based heating experiences at different positions within the package.

In one embodiment, power consumption of the intelligent heating system can be tracked and utilized in determining operation of the system. The system can utilize route mapping software to map a route and the time between each delivery location on the way. By mapping this against power usage and heating per order group, the usage of power for a vehicle to be managed for optimal delivery can be tracked as can the average power over time of delivery. Adjustments to the system can be made in order to conserve power consumed by the heating coil during delivery. For example, when delivering 6 large food items to 6 different locations that each require 1 kW of power to keep warm, a system with 3 kW of available power may determine that insufficient power is available to keep all 6 items hot, and so it instead rapidly heats individual items with 3 kW just before they are delivered.

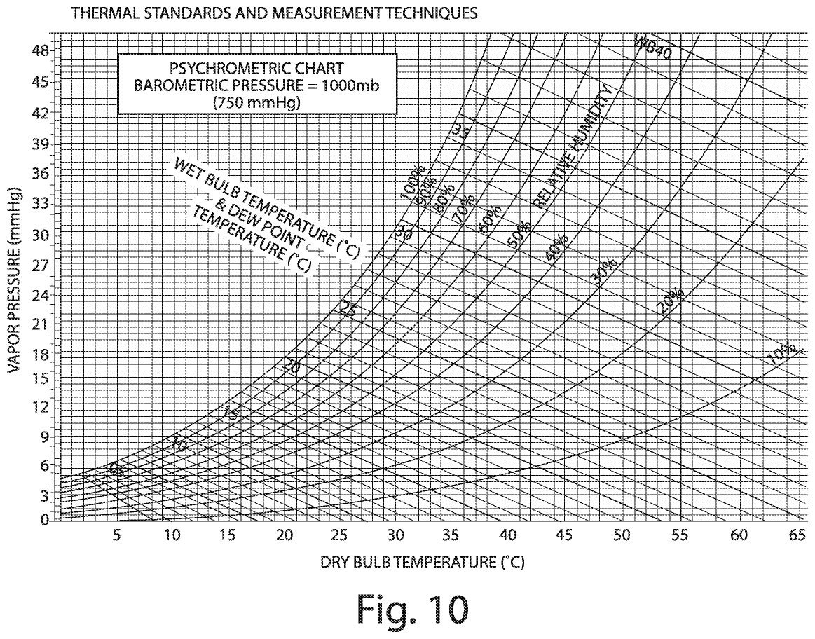

In one embodiment, the intelligent heating system can control the energy transfer to the food package in order to reduce or prevent condensation from forming on the internal surfaces of the food packaging. The intelligent heating system may include sensors that enable the system to track package temperature, outdoor temperature, ambient temperature, humidity, and other characteristics of the food package, food product, the finishing system, or the environment. With this feedback, the system can be configured to control waiting temperatures for optimum storage and delivery, providing reduced condensation within the package and helping to prevent soggy food. The finishing system can compare dry bulb vs. wet bulb temperatures and based on that comparison adjust the energy transfer system, effectively reducing or minimizing package condensation. FIG. 10 illustrates a psychometric chart, which illustrates the relationship between inside temperature, outside temperature, and humidity level. The finishing system can be configured to control the package temperature to stay under a predetermined relative humidity level at which a substantial amount of condensation forms. In essence, condensation forms when the walls of the container become cooler than the dew point of the air found inside the container. Accordingly, the intelligent heating system can utilize feedback from the various temperature sensors to keep the package warmer than the dew point. The inside temperature and food temperatures can be recorded and kept to ideal storage temperatures. The humidity can be calculated to assure food/package temperatures are monitored to reduce or minimize condensation.

For example, a heating package control system with humidity control can be provided. The system can include a support surface that receives a food package. The energy transfer system can be an inductive heating system that includes an inductive coil disposed in proximity of the support surface for inductively transferring energy to the food package. The system can include sensors to provide feedback for controlling the inductive heating system to prevent or reduce condensation from forming on the internal surfaces of the food package. The sensors can include an ambient temperature sensor for sensing an ambient temperature along with a humidity sensor for sensing a humidity level. The system can include a communication system configured to receive a food temperature from the food package sensor. In order to reduce or prevent condensation, a controller can be configured to automatically control energy applied to the inductive coil based on the humidity sensor, food temperature, and the ambient temperature such that condensation does not form on the food package. For example, an elevated ambient humidity may cause condensation within the package when a warm package is placed in a vehicle with a lower cabin temperature as the cool cabin temperature causes the sides of the package to cool, causing the moisture in the air within the food package to condense. To avoid this, heat is delivered to the package to keep the contents warm enough to avoid condensation. As the relative humidity increases and cabin temperature decreases, more heat is required to prevent condensation. For example, cooked rice may be kept at 85 C when placed in a cool humid vehicle (20 C with 85% relative humidity for example) to keep the package warm enough to prevent condensation. However, if the relative humidity is low and the cabin temperature is high (30 C with 15% relative humidity for example), food is more likely to dry out. In this situation, the package temperature may be kept as low as possible to prevent food drying from occurring, for example at about 75 C. The temperature adjustments may also adhere to any food safety limits (below a certain temperature bacteria begin to form), or by user experience (rice served colder than 75 C is a poor user experience regardless of food moisture). Alternatively, food may be allowed to cool enough to prevent drying out and then heated back up just before being delivered.

The order, temperatures, times, and quality information can be pushed to the Web for the customer and the restaurant or merchant. The system may include a pick-up or delivery checklist that can be ready by RFID and reported to the cloud. It enables a final check of everything expected in a particular order. All orders and complaints can be tracked against what was packaged, when it was delivered and where, and what was ordered.

The control system can utilize the pick-up and delivery time information to estimate a storage and end temperature profile. The control system can reduce or minimize power over that profile for the heated packages. The control system can also provide order identification upon delivery or pick-up and can also track the delivery and temperatures over the profile providing analytics for users about food quality, temperature, and other information.

The intelligent heating system provides, in one embodiment, a heated package pick-up and delivery system and method for increasing the consumption experience for a consumer. The heated package system dynamically controls temperatures of multiple packages, for example to specific targets associated with the food package and its contents. The management of the heated package sequence and timing enables monitoring the time and energy expenditure. The system can be configured to be cloud-enabled and connected to the point of sale and an order management system.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. An intelligent heating system for heating food, the intelligent heating system comprising:
an order system configured to receive an indication regarding a food order of a food item;
an initial cooking system configured to partially cook the food item;
a communication system for receiving location information from a remote device; and
a finishing heating system including an energy transfer system and a control system, wherein the control system is configured to selectively control the energy transfer system to finish cooking the partially cooked food item in response to the location information.

2. The intelligent heating system of claim 1 wherein the communication system periodically receives location information from the remote device indicative of a current location of the customer, wherein the control system is configured to automatically control the energy transfer system by adjusting the energy transfer system between providing a warming heating experience and a finishing heating experience to the partially cooked food item based on the location information from the remote device indicative of the current location of the customer.

3. The intelligent heating system of claim 2 wherein the control system is configured selectively control the energy transfer system to provide a warming heating experience while the distance between the current location of the customer and the intelligent heating system is greater than a predetermined distance and wherein the control system is configured to automatically control the energy transfer system to provide a finishing heating experience to the partially cooked food item while the distance between the current location of the customer and the intelligent heating system is less than the predetermined distance.

4. The intelligent heating system of claim 1 wherein the location information includes information indicative of an estimated time of arrival of the customer, wherein the control system is configured to automatically control the energy transfer system by adjusting the energy transfer system between providing a warming heating experience and a finishing heating experience to the partially cooked food item based on the information indicative of the estimated time of arrival of the customer.

5. The intelligent heating system of claim 4 wherein the control system is configured to automatically control the energy transfer system to provide a finishing heating experience to the partially cooked food item in response to a difference between an amount of time to complete the finishing heating experience and the estimated time of arrival of the customer being below a pre-determined threshold.

6. The intelligent heating system of claim 1 further including a delivery destination stored in memory, wherein the communication system periodically receives location information from the remote device indicative of a current location of a delivery vehicle, wherein the control system is configured to automatically control the energy transfer system by adjusting the energy transfer system between providing a warming heating experience and a finishing heating experience to the partially cooked food item based on distance between the delivery destination and the current location of the delivery vehicle.

7. The intelligent heating system of claim 1 wherein the location information includes information indicative of an estimated time of arrival of the delivery vehicle, wherein the control system is configured to automatically control the energy transfer system by adjusting the energy transfer system between providing a warming heating experience and a finishing heating experience to the partially cooked food item based on the information indicative of the estimated time of arrival of the delivery vehicle.

8. The intelligent heating system of claim 7 wherein the control system is configured to automatically control the energy transfer system to provide a finishing heating experience to the partially cooked food item in response to a difference between an amount of time to complete the finishing heating experience and the estimated time of arrival of the delivery vehicle being below a pre-determined threshold.

9. The intelligent heating system of claim 1 wherein the order system is configured to receive a plurality of food orders each including a delivery destination and one or more food items, wherein the initial cooking system is configured to partially cook each of the one or more food items in each of the plurality of food orders, wherein the intelligent heating system includes a routing system for determining a delivery route for delivering the plurality of food orders, wherein the control system is configured to automatically control the energy transfer system by adjusting the energy transfer system between providing a warming heating experience and a finishing heating experience for each of the food orders based on the delivery route and the current location of the delivery vehicle.

10. A cooking apparatus comprising:
a support surface for receiving a food package including a food item within the package;
an energy transfer element disposed in proximity of the support surface for transferring energy to the food package for heating the food item within the package; and
a controller configured to selectively control energy applied to the energy transfer element based on information from a radio location system.

11. The cooking apparatus of claim 10 wherein the cooking apparatus includes a communication system that periodically receives information indicative of an estimated time of arrival of the customer from the radio location system of a customer, wherein the controller is configured to automatically adjust the energy applied to the energy transfer element to provide at least one of a first heating experience and a second heating experience to the food item based on the information indicative of the estimated time of arrival of the customer.

12. The cooking apparatus of claim 11 wherein the controller is configured to automatically adjust the energy applied to the energy transfer element to provide the second heating experience to the food item in response to a difference between an amount of time to complete the second heating experience and the estimated time of arrival of the customer being below a threshold.

13. The cooking apparatus of claim 10 wherein the cooking apparatus includes a radio location system that provides to the controller, information indicative of an estimated time of arrival of a delivery vehicle, wherein the controller is configured to automatically adjust the energy applied to the energy transfer element to provide at least one of a first heating experience and a second heating experience to the food item based on the information indicative of the estimated time of arrival of the delivery vehicle.

14. The cooking apparatus of claim 13 wherein the controller is configured to automatically adjust the energy applied to the energy transfer element to provide the second heating experience to the food item in response to a difference between an amount of time to complete the second heating experience and the estimated time of arrival of the delivery vehicle being below a threshold.

15. An inductive warming rack comprising:
compartments for receiving food packages having an RFID tag including order information;
energy transfer elements disposed in proximity of the compartments for transferring energy to food package stored therein;
RFID coils disposed in proximity of the compartments for identifying food packages stored therein by reading the order information from the RFID tags of the food packages stored therein; and
a control system in communication with the RFID coils for receiving the order information identifying, by compartment, locations of the food packages stored, the control system configured to control energy applied to the energy transfer elements to provide heating experiences to the food packages stored in the compartments based on the order information.

16. The inductive warming rack of claim 15 wherein the inductive warming rack is installed at a restaurant and wherein the controller communicates order information to a tracking system and receives instructions from the tracking system based on estimated times of customer arrival associated with the order information, wherein the control system is configured to control the energy applied to the plurality of energy transfer elements to provide heating experiences to the plurality of food packages based on the estimated times of customer arrival associated with the order information.

17. The inductive warming rack of claim 15 wherein the inductive warming rack is configured for installation in a delivery vehicle and wherein the controller communicates order information to a tracking system and receives instructions from the tracking system based on estimated times of delivery vehicle arrival associated with the order information, wherein the control system is configured to control the energy applied to the energy transfer elements to provide heating experiences to the food packages based on the estimated times of delivery vehicle arrival associated with the order information.

18. A heating package control system comprising
a support surface for receiving a food package;
an inductive coil disposed in proximity of the support surface for inductively transferring energy to the food package;
an ambient temperature sensor for sensing an ambient temperature;
a feedback system configured to receive a food temperature from the food package;
a humidity sensor for sensing a humidity level; and
a controller configured to automatically control energy applied to the inductive coil based on the humidity sensor, food temperature, and the ambient temperature such that condensation formed on the food package is reduced.

19. The heating package control system of claim 18 wherein the controller is configured to automatically control energy applied to the inductive coil based on the humidity sensor, food temperature, and the ambient temperature such that condensation does not form on the food package.

20. The heating package control system of claim 18 wherein the controller is configured to automatically adjust energy applied to the inductive coil based on the humidity sensor, food temperature, and the ambient temperature to balance condensation and heating experience of the food package.
